(19) United States
(12) Patent Application Publication
(10) Pub. No.: US 2022/0284268 A1
(43) Pub. Date: Sep. 8, 2022

(54) DISTRIBUTED PROCESSING OF SYNAPTIC CONNECTIVITY GRAPHS

(71) Applicant: X Development LLC, Mountain View, CA (US)

(72) Inventors: Sarah Ann Laszlo, Mountain View, CA (US); Farooq Ahmad, Shoreline, WA (US)

(21) Appl. No.: 17/195,395

(22) Filed: Mar. 8, 2021

(51) Int. Cl. G06N 3/04; G06N 3/063

(52) U.S. Cl. CPC G06N 3/0454; G06N 3/063

(57) ABSTRACT

In one aspect, there is provided a method performed by multiple data processing units for distributed processing of data defining a synaptic connectivity graph that includes multiple nodes and edges and represents synaptic connectivity between neurons in a brain of a biological organism. The method includes obtaining graph data defining the synaptic connectivity graph that represents synaptic connectivity between neurons in the brain of the biological organism. The method further includes dividing the graph data defining the synaptic connectivity graph into multiple sub-graph datasets that each define a respective sub-graph of the synaptic connectivity graph. The method further includes distributing multiple sub-graph datasets over multiple data processing units and processing multiple sub-graph datasets using multiple data processing units.

### BACKGROUND

This specification relates to distributed processing of synaptic connectivity graphs.

Distributed processing can refer to using multiple processing units to process data. A processing unit can be a computer, a core within a computer having multiple cores, or other hardware or software, such as a dedicated thread, within a computer capable of independently performing operations. The processing units can include processor cores, processors, microprocessors, special-purpose logic circuitry, e.g., an FPGA (field-programmable gate array) or an ASIC (application-specific integrated circuit), or any other appropriate processing units. The processing units can be all of the same type, or different types. One processing unit can be a CPU while other processing units can be GPUs.

### SUMMARY

This specification describes a system implemented as computer programs on one or more computers in one or more locations for analyzing a biological connectome using distributed processing techniques.

According to a first aspect, there is provided a method performed by multiple data processing units for distributed processing of data defining a synaptic connectivity graph that represents synaptic connectivity between neurons in a brain of a biological organism. The synaptic connectivity graph includes multiple nodes and edges. The method includes obtaining graph data defining the synaptic connectivity graph that represents synaptic connectivity between neurons in the brain of the biological organism. The method further includes dividing the graph data defining the synaptic connectivity graph into multiple sub-graph datasets that each define a respective sub-graph of the synaptic connectivity graph. The method further includes distributing multiple sub-graph datasets over multiple data processing units, which includes assigning each sub-graph dataset to a respective data processing unit. The method further includes processing multiple sub-graph datasets using multiple data processing units, which includes, for each of multiple data processing units, processing one or more sub-graph datasets that are assigned to the data processing unit.

In some implementations, each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism.

In some implementations, for each of the multiple data processing units, processing one or more sub-graph datasets that are assigned to the data processing unit includes, for each sub-graph dataset that is assigned to the data processing unit: instantiating a reservoir computing neural network including: a sub-graph neural network having a neural network architecture that is specified by the sub-graph dataset, and a prediction neural network.

In some implementations, instantiating the reservoir computing network includes instantiating the sub-graph neural network having the neural network architecture that is specified by the sub-graph dataset, which includes: mapping each node in the sub-graph dataset to a corresponding artificial neuron in the neural network architecture, and mapping each edge connecting a pair of nodes in the sub-graph dataset to a connection between a corresponding pair of artificial neurons in the neural network architecture.

In some implementations, the method further includes training the reservoir computing network and evaluating a performance of the reservoir computing network on a machine learning task. The performance of the reservoir computing network is characterized by a performance measure.

In some implementations, the machine learning task is an image processing task, an audio data processing task, an odor processing task, or a natural language processing task.

In some implementations, for each of multiple data processing units, processing one or more sub-graph datasets that are assigned to the data processing unit includes, for each sub-graph dataset that is assigned to the data processing unit: rendering a visualization of the sub-graph dataset by the data processing unit.

In some implementations, the visualization includes multiple markers. Each marker indicates a position of each node, and the position of each node is defined by a position of a corresponding neuron in the brain of the biological organism.

In some implementations, the method further includes aggregating visualizations of the sub-graph datasets generated by each processing unit to generate a visualization of a whole of the synaptic connectivity graph.

In some implementations, for each of the multiple data processing units, processing one or more sub-graph datasets that are assigned to the data processing unit includes, for each sub-graph dataset that is assigned to the data processing unit: calculating graph statistics characterizing the sub-graph dataset, the graph statistics including one or more of: a sum of clustering coefficients for each node in the sub-graph dataset averaged over a total number of nodes in the sub-graph dataset, a total number of loops in the sub-graph dataset averaged over the total number of nodes in the sub-graph dataset, a total number of edges connected to each node in the sub-graph dataset averaged over the total number of nodes in the sub-graph dataset, and a small-world parameter for the sub-graph dataset.

In some implementations, each division of the graph data defining the synaptic connectivity graph into multiple sub-graph datasets is associated with a respective score. Dividing the graph data includes: determining the division of the graph data into multiple sub-graph datasets, by a graph clustering algorithm, to optimize the score associated with the division of the graph data into multiple sub-graph datasets.

In some implementations, the score is based on one or more of: small-world parameters of each sub-graph, average clustering coefficient of each sub-graph, average number of edges connected to each node in each sub-graph, average number of loops in each sub-graph.

In some implementations, the biological organism is an animal.

In some implementations, the biological organism is a fly.

In some implementations, multiple data processing units process the sub-graph datasets in parallel.

According to a second aspect there are provided one or more non-transitory computer storage media storing instructions that when executed by multiple data processing units cause multiple data processing units to perform the operations of the method of any preceding aspect.

According to a third aspect there is provided a system including: multiple processing units, and one or more storage devices communicatively coupled to the multiple processing units, where the one or more storage devices store instructions that, when executed by multiple processing units, cause multiple processing units to perform the operations of the method of any preceding aspect.

Particular embodiments of the subject matter described in this specification can be implemented so as to realize one or more of the following advantages.

The systems described in this specification can efficiently and robustly analyze data corresponding to the brain of a biological organism, which can be in the form of e.g., a synaptic connectivity graph, where each node of the synaptic connectivity graph corresponds to a neuron in the brain, and two nodes in the synaptic connectivity graph are connected if the corresponding neurons in the brain share a synaptic connection.

Generally, the dataset corresponding to the synaptic connectivity graph is enormous due to the large number of neurons and synaptic connections that the brain contains. For example, a fly brain may have on the order of ˜10⁵ neurons or more. This makes simulating the entire synaptic connectivity graph very computationally intensive. The systems described in this specification can generate a synaptic connectivity graph based on the dataset representing the brain of the biological organism and intelligently divide it into sub-graph datasets. By leveraging distributed processing techniques (e.g., by processing the synaptic connectivity graph using a number of processing units), the systems described in this specification can analyze each of the sub-graph datasets efficiently and robustly. Moreover, since analyzing the entire synaptic connectivity graph using a single processing unit can be computationally infeasible in practice, distributed processing makes analyzing the entire synaptic connectivity graph possible, thereby improving computational performance and efficiency.

The systems described in this specification can generate a sub-graph neural network architecture corresponding to a sub-graph of the synaptic connectivity graph and use it in reservoir computing applications. In particular, a “reservoir computing” neural network may be implemented with an architecture specified by the sub-graph neural network followed by a “prediction” sub-network. Generally, the prediction sub-network may have a substantially less complex architecture than the sub-graph neural network, e.g., the prediction sub-network may consist of a single classification layer. During training of the reservoir computing neural network, only the weights of the prediction sub-network are trained, while the weights of sub-graph neural network are considered static and are not trained.

Generally, a sub-graph neural network may have a very large number of trainable parameters and a highly recurrent architecture. Therefore training the sub-graph neural network may be computationally-intensive and prone to failure, e.g., as a result of the model parameter values of the sub-graph neural network oscillating rather than converging to fixed values. The reservoir computing neural network described in this specification may harness the capacity of the sub-graph neural network, e.g., to generate representations that are effective for solving tasks, without requiring the sub-graph neural network to be trained.

The systems described in this specification can implement sub-graph neural networks as individual reservoir computing networks and simulate them in a distributed manner, e.g., each reservoir computing network can be instantiated on an individual processing unit and processed in parallel. This can allow simulating the entire synaptic connectivity graph in a reasonable amount of time. Further, the systems described in this specification can train each individual reservoir computing network on a set of training data and assess its performance on a particular machine learning task using validation data. In this way, the systems can determine regions of the synaptic connectivity graph (e.g., of the brain) that are particularly effective at solving tasks. For example, it may be possible to identify the most optimal region of the brain for visual reconstruction in noisy conditions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of obtaining a synaptic connectivity graph from a synaptic resolution image of the brain of a biological organism and providing the graph to a distributed processing system.

FIG. 2 illustrates an example of processing a synaptic connectivity graph using a distributed processing system.

FIG. 3 is a flow diagram of an example process for distributed processing of data defining a synaptic connectivity graph.

FIG. 4 shows an example reservoir computing system.

FIG. 5 is a flow diagram of an example process for processing data using a reservoir computing neural network that includes: (a) a sub-graph neural network, and (ii) a prediction sub-network.

FIG. 6 shows an example data flow for generating a synaptic connectivity graph based on the brain of a biological organism.

FIG. 7 is a flow diagram of an example process for generating a neural network architecture specified by a sub-graph of the synaptic connectivity graph.

FIG. 8 is a block diagram of an example computer system.

Like reference numbers and designations in the various drawings indicate like elements.

### DETAILED DESCRIPTION

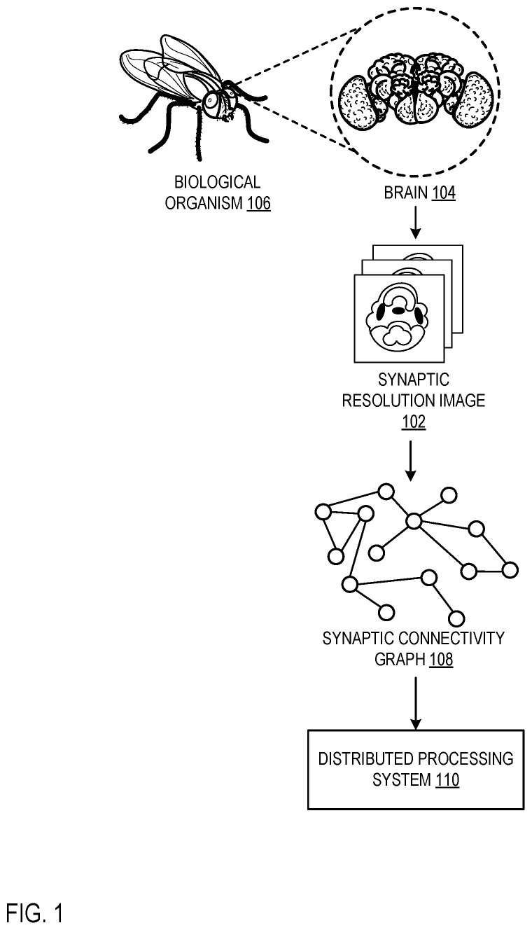

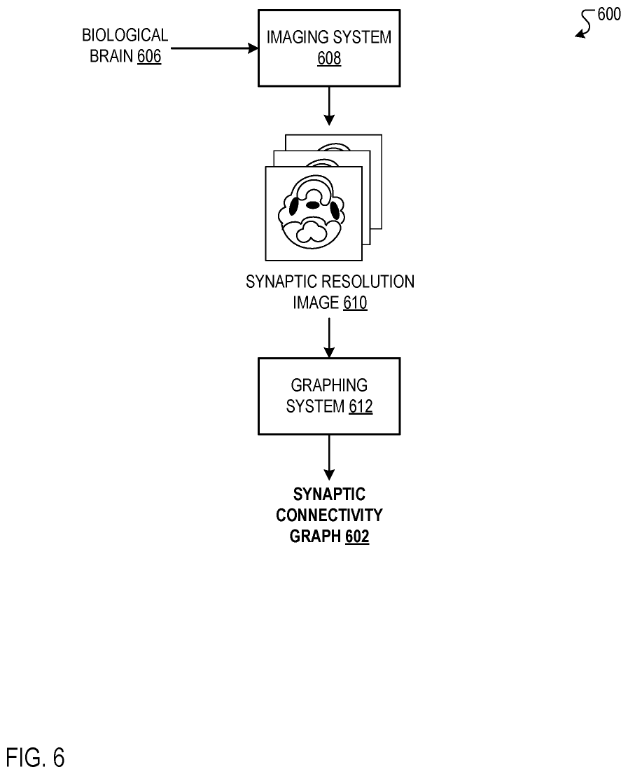

FIG. 1 illustrates an example of obtaining a synaptic connectivity graph 108 from a synaptic resolution image 102 of the brain 104 of a biological organism 106. As used throughout this document, the brain 104 may refer to any amount of nervous tissue from a nervous system of the biological organism 106, and nervous tissue may refer to any tissue that includes neurons (i.e., nerve cells). The biological organism 106 may be, e.g., a worm, a fly, a mouse, a cat, or a human. The synaptic resolution image 102 may be processed to generate a synaptic connectivity graph 108, e.g., where each node of the graph 108 corresponds to a neuron in the brain 104, and two nodes in the graph 108 are connected if the corresponding neurons in the brain 104 share a synaptic connection. This process is described in more detail below with reference to FIG. 6. The data defining the synaptic connectivity graph 108 can be processed by using the distributed processing system 110, which can divide the dataset corresponding to the synaptic connectivity graph 108 into a number of sub-graph datasets, each representing a sub-graph of the synaptic connectivity graph 108, and distribute the data-sets across a number of processing units.

A processing unit may be, e.g., a computer, a core within a computer having multiple cores, or other hardware or software, e.g., a dedicated thread, within a computer capable of independently performing operations. The processing units may include processor cores, processors, microprocessors, special-purpose logic circuitry, e.g., an FPGA (field-programmable gate array) or an ASIC (application-specific integrated circuit), or any other appropriate processing units. In some examples, the processing units are all the same type of processing unit. In other examples, the processing units may be different types of processing units. For example, one processing unit may be a CPU while other processing units may be GPUs.

Generally, mapping biological neural networks at the level of synaptic connections generates enormous datasets due to the large number of neurons and synaptic connections contained in the brain 104. Accordingly, there exists a need for computational techniques that would allow analyzing data defining the brain 104 efficiently and reliably. A technique of analyzing the synaptic connectivity graph using distributed processing techniques is described in more detail below.

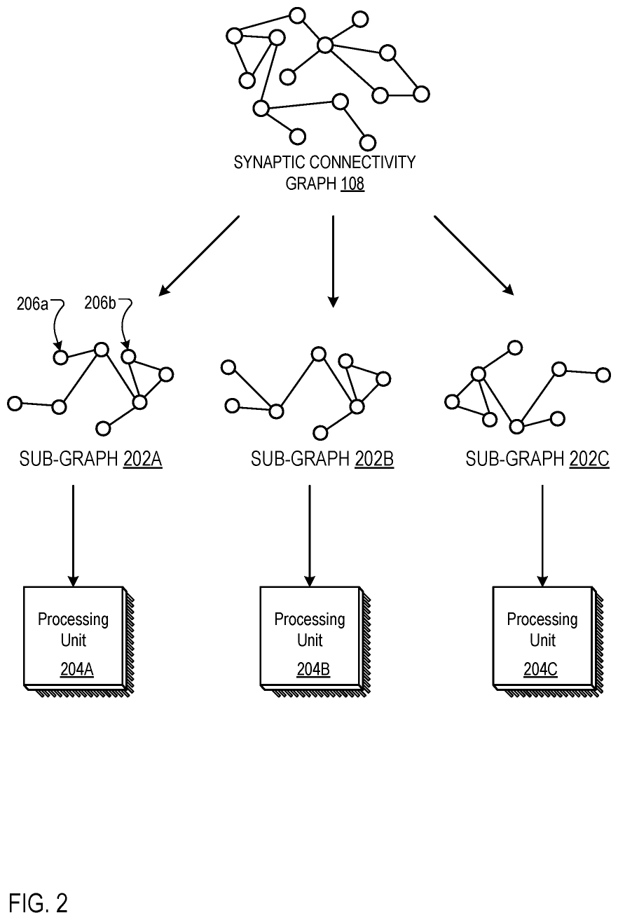

FIG. 2 illustrates an example of processing a synaptic connectivity graph 108 based on the brain 104 of a biological organism 106 by using a distributed processing system 110. The synaptic connectivity graph 108 corresponding to the brain 104 of the biological organism 106 may be represented in any of a variety of ways. For example, the graph 108 may be represented as a two-dimensional array of numerical values with a number of rows and columns equal to the number of nodes in the graph. The component of the array at position (i,j) may have value 1 if the graph includes an edge pointing from node i to node j, and value 0 otherwise. The weight values for each edge in the graph 108 may be similarly represented as a two-dimensional array of numerical values.

More specifically, if the graph includes an edge connecting node i to node j, the component of the array at position (i,j) may have a value given by the corresponding edge weight, and otherwise the component of the array at position (i,j) may have value 0. Each node in the synaptic connectivity graph 108 can have a respective three-dimensional coordinate specifying the position of the corresponding neuron in the brain 104, which can be derived from the three-dimensional synaptic resolution image 102. Accordingly, the dataset corresponding to the graph 108 may also be represented as a 3×N dimensional matrix, specifying x, y, and z, coordinates for each of the N number of nodes in the graph 108 (e.g., neurons in the brain 104).

The distributed processing system 110 can divide the synaptic connectivity graph 108 into a number of sub-graphs (202A, 202B, 202C), where each sub-graph (202A, 202B, 202C) corresponds to a sub-set of data defining the synaptic connectivity graph 108, e.g., a subset of nodes and edges defining the synaptic connectivity graph 108.

In one example, the distributed processing system 110 can divide the synaptic connectivity graph 108 into sub-graphs (202A, 202B, 202C) based on the respective Cartesian coordinates of each node and edge in the graph (e.g., based on the anatomic proximity of neurons and synaptic connections in the brain). More specifically, the distributed processing system 110 can approximate the brain 104 as a rectangular volume, partition the volume into cubes and identify the nodes and edges of the synaptic connectivity graph 108 that are contained in each cube. Then, the distributed processing system 110 can generate a set of sub-graphs (202A, 202B, 202C), where the nodes and edges contained in each individual cube correspond to nodes and edges contained in each individual sub-graph. The rectangular volume corresponding to the brain can be partitioned by the distributed processing system 110 into cubes of the same size, or different sizes. Further, the cubes can be separate or overlapping.

In another example, the distributed processing system 110 can be configured to associate a respective division score with each division of the synaptic connectivity graph 108 into sub-graphs (202A, 202B, 202C). The division score can be based on, e.g., scores associated with the sub-graphs, where a sub-graph score can depend on the statistical parameters associated with that sub-graph. The division score associated with a division of the synaptic connectivity graph 108 into sub-graphs (202A, 202B, 202C) can be determined by, e.g., calculating a sum of the scores for the sub-graphs, or by calculating an average score for the sub-graphs. The distributed processing system 110 can apply a “graph clustering” algorithm to estimate a division of the synaptic connectivity graph 108 into sub-graphs (202A, 202B, 202C) in such a way so as to approximately, or exactly, optimize the division score of the selected division.

In one example, the score for a sub-graph can be based on a sum, or an average across all nodes in the sub-graph, of clustering coefficients associated with each node in the sub-graph (202A, 202B, 202C). The clustering coefficient for each node can be determined by calculating, for each node, the fraction of the node's neighbors in the sub-graph (202A, 202B, 202C) that are also neighbors of each other.

In another example, the score for a sub-graph can be based on the total number of loops in the sub-graph (202A, 202B, 202C), or the average number of loops across all nodes in the sub-graph, where a loop can be defined as a connection from each component (e.g., a node) in a sequence to the next component where the first and last components of the sequence are identical.

In yet another example, the score for a sub-graph can be determined by calculating, for each node in the sub-graph, the number of edges connected to the node, and calculating the total number of nodes in the sub-graph that have a pre-determined number of edges as connections (e.g., the number of nodes with 3 or more edges connecting to it).

In yet another example, the score for a sub-graph can be based on small-world properties of the sub-graph. Each sub-graph can have a small-world parameter Σ associated with it, which can be defined as

$$\sum = \frac{C}{{C}_{r}} \div \frac{L}{{L}_{r}} ,$$

where C is the average clustering coefficient of the sub-graph and L is the average shortest path length of the sub-graph, while Cᵣ and Lᵣ are corresponding parameters for an equivalent random graph (e. g., a graph that is not derived from the synaptic connectivity graph such as a lattice graph). Generally, a small-world graph has a relatively high local clustering coefficient and a relatively short average path length, e.g., small average number of edges along the shortest paths for all possible pairs of nodes in the graph.

The distributed processing system 110 can calculate the division score associated with each division of the synaptic connectivity graph 108 into sub-graphs (202A, 202B, 202C) based on any other statistical parameter or score associated with each of the sub-graphs (202A, 202B, 202C).

The distributed processing system 110 can use any appropriate graph clustering algorithm to determine a division of the synaptic connectivity graph into sub-graphs so as to approximately, or exactly, optimize the score associated with the division, e.g., Graph Cuts, K-Means and K-D Tree. Example “graph clustering” algorithms are described with reference to: X. Xu et al., “SCAN: a structural clustering algorithm for networks,” doi:10.1145/1281192.1281280 (2007), and S. Gregory, “A Fast Algorithm to Find Overlapping Communities in Networks,” doi: 10.1007/978-3-540-87479-9_45 (2008).

The distributed processing system 110 can divide the synaptic connectivity graph 108 into sub-graphs (202A, 202B, 202C), such that there are no edges and nodes shared between the sub graphs, or it can divide the synaptic connectivity graph 108 into overlapping sub-graphs (202A, 202B, 202C), such that some of the nodes/edges contained in one sub-graph are also contained in a different sub-graph.

The distributed processing system 110 can assign each sub-graph (202A, 202B, 202C) to an individual processing unit (204A, 204B, 204C) and process each sub-graph in parallel.

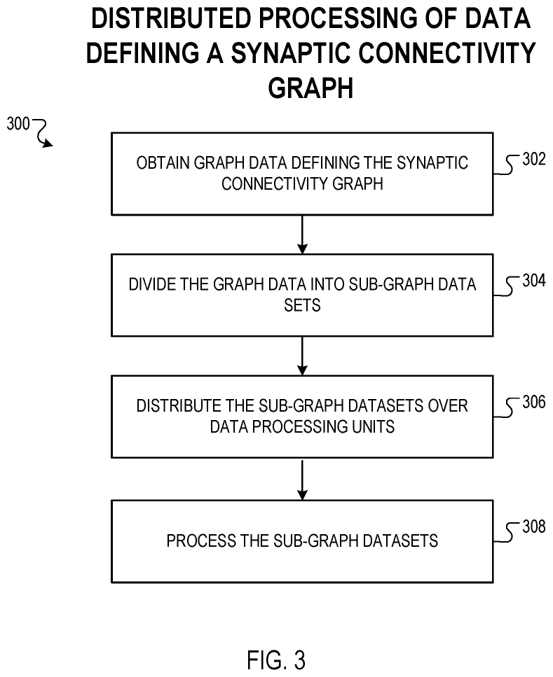

FIG. 3 is a flow diagram of an example process 300 for distributed processing of data defining the synaptic connectivity graph 108 that represents synaptic connectivity between neurons in the brain 104 of the biological organism 106. For convenience, the process 300 will be described as being performed by the distributed processing system 110, which is a system of one or more computers located in one or more locations.

The distributed processing system 110 obtains graph data defining the synaptic connectivity graph 108 that represents synaptic connectivity between neurons in the brain 104 of the biological organism 106 (302). This process is described in more detail with reference to FIG. 1.

Next, the distributed processing system 110 divides the graph data defining the synaptic connectivity graph 108 into a number of sub-graph datasets that each define a respective sub-graph of the synaptic connectivity graph 108 (304), as described above.

Next, distributed processing system 110 distributes the sub-graph datasets over a number of data processing units by assigning each sub-graph dataset to a respective data processing unit (306). The sub-graph datasets can be randomly assigned to processing units. Alternatively, each processing unit can calculate a certain parameter, e.g., calculate a certain sub-graph statistic, and the processing unit to which a particular sub-graph dataset is assigned can be determined by a desired parameter to be calculated for the sub-graph. Further, the distributed processing system 110 can assign the same sub-graph dataset to multiple processing units if, for example, it is desirable to calculate multiple parameters for that particular sub-graph dataset. In this case, multiple processing units can process the same sub-graph dataset to simultaneously calculate multiple parameters for the sub-graph.

Next, the distributed processing system 110 processes the sub-graph datasets using the data processing units (308). The distributed processing system 110 can include multiple processing units, and each processing unit can be assigned at least one sub-graph dataset. The processing units can process each of the sub-graph datasets in parallel e.g., simultaneously, while the processing units can finish processing at different times. Further, the distributed processing system 110 can utilize load balancing techniques to minimize the idle time of processing units.

Each processing unit processes one or more sub-graph datasets that are assigned to it. Processing a sub-graph can include, e.g., calculating graph statistics for the sub-graph. This can include calculating small-world properties of each sub-graph, or any other statistical parameters, as described above. By processing the sub-graphs using multiple processing units and aggregating the outcomes, the processing units are able to determine graph statistics for the entire synaptic connectivity graph 108, such as, for example, the distribution of a particular statistical parameter across the entire synaptic connectivity graph 108. Further, the processing units can map a sub-graph to a particular region of the brain 104 of the biological organism 106 based on the statistical parameters. For example, if a sub-graph has a high degree of recurrence (e.g., a large number of loops), it may correspond to the part of the brain 104 that contains a large number of visual neurons. In this way, the processing units can not only analyze the entire synaptic connectivity graph 108 (e.g., the entire brain 104 of the biological organism 106), but also do so efficiently and robustly.

In yet another example, processing the sub-graph datasets using the processing units can also include rendering a visualization of the entire synaptic connectivity graph 108 (e.g., of the entire brain 104 of the biological organism 106), which can show markers (e.g., spheres) indicating the positions of the nodes of the synaptic connectivity graph, where the position of each node is defined by the position (e.g., in Cartesian coordinates) of the corresponding neuron in the brain of the biological organism. For example, each of the processing units can render a visualization of one or more sub-graphs that are assigned to it, and the visualizations can be aggregated to generate an overall visualization of the entire synaptic connectivity graph 108.

Further, distributed processing system 110 can allow examining the aggregated visualization of the synaptic connectivity graph 108 at various magnifications by allowing to “zoom-in” on (e.g., magnify) a particular sub-graph of the synaptic connectivity graph 108. For example, a particular sub-graph dataset can be divided further into even smaller sub-graph datasets and assigned by the distributed processing system 110 over multiple processing units. Each of the processing units can render a respective visualization of each of the smaller datasets which, when aggregated, can allow to view a magnified version of the original sub-graph.

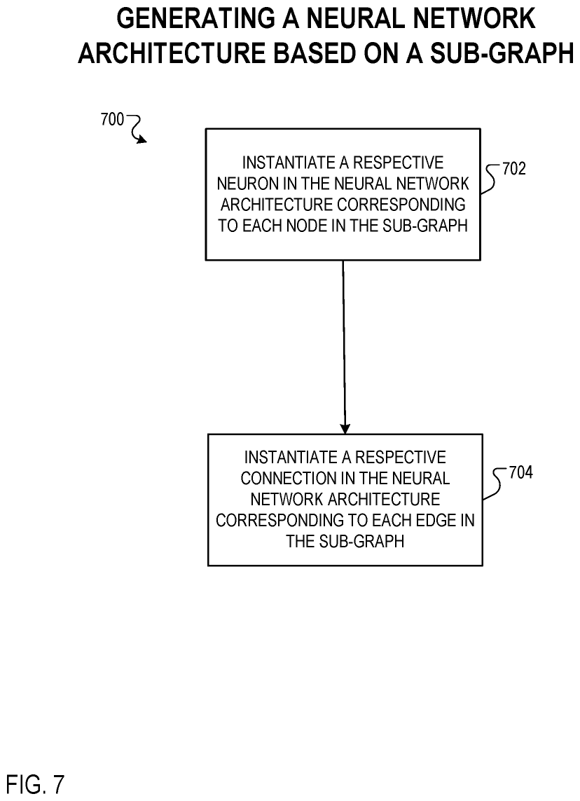

In another example, processing the sub-graph datasets using the processing units can also include implementing each sub-graph as a reservoir computing neural network, where the reservoir is defined by a portion of the synaptic connectivity graph 108 (e.g., a portion of the brain 104 of the biological organism 106). In some instances, that portion of the synaptic connectivity graph 108 can be too big to be implemented by a single processing unit. The distributed processing system 110 can divide the portion of the synaptic connectivity graph 108 into sub-graph datasets, as described above with reference to FIG. 2, and assign each sub-graph dataset to a respective processing unit. Then, an architecture mapping system can map each sub-graph onto a corresponding sub-graph neural network architecture, as described below with reference to FIG. 7, by mapping each node in the sub-graph onto a corresponding artificial neuron and each edge between a pair of nodes in the sub-graph onto a connection between a corresponding pair of artificial neurons in the neural network architecture.

In this way, the processing units can instantiate a reservoir computing network with a neural network architecture corresponding to the part of the synaptic connectivity graph 108 that is too big to be implemented on a single processing unit by instantiating individual sub-graph neural network architectures across multiple processing units, which collectively implement the neural network architecture corresponding to the part of the synaptic connectivity graph 108.

In reservoir computing implementations, the distributed processing system 110 can base the score associated with the division of the synaptic connectivity graph 108 on small-world properties of each of the sub-graphs. By ensuring that each of the sub-graphs is a small-world graph, e.g., each of the sub-graphs has the small-world statistical properties as described above, the distributed processing system 110 can maximize message passing (e.g., information flow between the nodes) within each of the sub-graphs, while minimizing message passing between each individual sub-graph. In this way, the computational efficiency of collective implementation of the neural network architecture corresponding to the synaptic connectivity graph can be greatly improved.

In yet another example, processing the sub-graph datasets using multiple processing units can include identifying which of the sub-graphs is particularly effective at performing a machine learning task. For example, each of the processing units can instantiate a neural network architecture corresponding to the sub-graph as the reservoir of a reservoir computing neural network, train the reservoir computing neural network on a set of training data, and evaluate its performance at a particular machine learning task by, e.g., calculating a performance measure associated with the performance of the sub-graph neural network at the machine learning task. The processing units can aggregate the performance measures calculated for each of the sub-graph neural networks, identify most effective sub-graph neural network at performing the machine learning task (e.g., identifying the sub-graph with the highest performance measure), and provide the sub-graph neural network for performing the machine learning task.

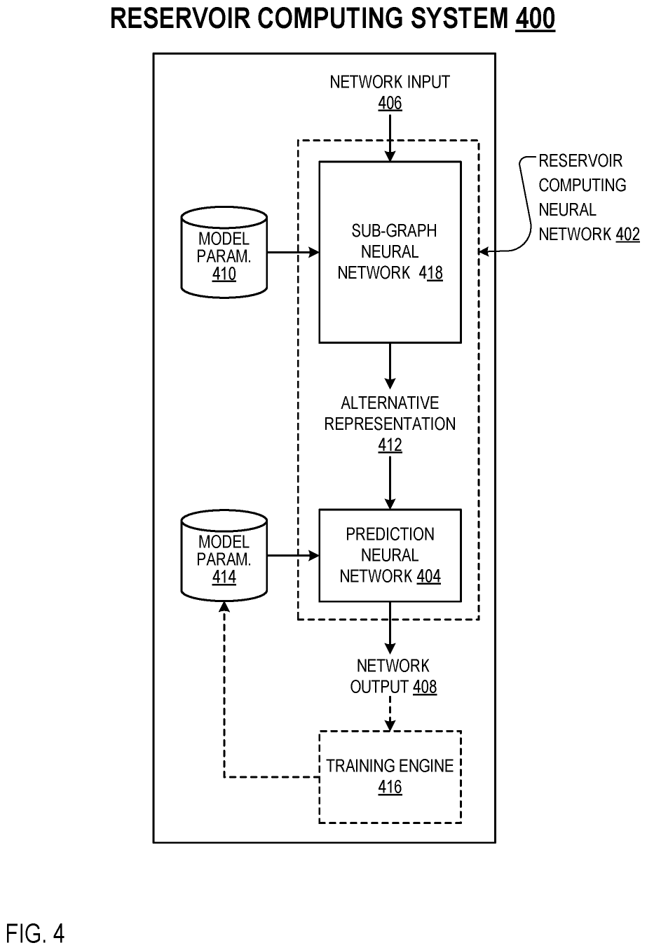

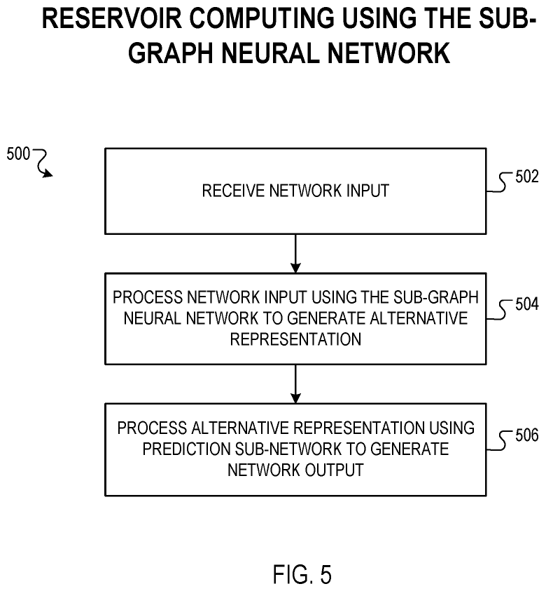

An example reservoir computing network is described in more detail below with reference to FIG. 4, and an example process for processing data using a reservoir computing network that includes a sub-graph neural network is described in more detail below with reference to FIG. 5. A few examples of possible machine learning tasks are described in more detail next.

In some implementations, the machine learning task can be an image processing task, e.g., processing an image to generate data characterizing the image. For example, the machine learning task can be a pixel-wise segmentation task, e.g., processing an image to generate, for each pixel of the image, a respective score for each of multiple possible categories, where the score for a category defines a likelihood that the pixel is included in the category. The categories can be, e.g., object categories, or any other appropriate categories. As another example, the machine learning task can be an image classification task, e.g., processing an image to generate a respective score for each of multiple possible classes, e.g., object classes, such that the machine learning task is an object recognition task.

In some implementations, the machine learning task can be an audio data processing task, e.g., processing audio data to generate an output characterizing the audio data. For example, the machine learning task can be a speech recognition task, e.g., processing an audio waveform to generate a sequence of graphemes, phonemes, characters, word fragments, or words, corresponding to the audio waveform. As another example, the machine learning task can be a “hot word” classification task, e.g., processing an audio waveform to generate a score defining a likelihood that a specified word or phrase is uttered in the audio.

In some implementations, the machine learning task is an odor processing task, e.g., processing odor data to generate an output characterizing the odor data. For example, the machine learning task can be an odor classification task, e.g., processing odor data to generate a respective for each of multiple possible odor categories, e.g., “sweet,” “putrid,” or “musky.” The score for an odor category can define a likelihood that the odor data is included in the odor category.

In some implementations, the machine learning task is a radar or lidar data processing task e.g., processing radar or lidar data to generate an output characterizing the radar or lidar data. For example, the machine learning task can be an object recognition task, e.g., processing a point cloud representing lidar data to generate a respective score for each of multiple possible object categories, where the score for an object category can define a likelihood that the lidar data depicts an object in the object category.

In some implementations, the machine learning task is a natural language processing task, e.g., processing an input sequence of textual data to generate an output characterizing the textual data. For example, the machine learning task can be a machine translation task, e.g., processing an input sequence of text in a first natural language (e.g., English) to generate an output sequence of text in a second, different natural language (e.g., French).

As described above, processing each of the sub-graph datasets using multiple processing units can include implementing each sub-graph as part of a reservoir computing neural network. FIG. 4 shows an example reservoir computing system 400. The reservoir computing system 400 is an example of a system implemented as computer programs on one or more computers in one or more locations in which the systems, components, and techniques described below are implemented.

Generally, a reservoir computing neural network is a neural network that can include: (i) a sub-network specified by a synaptic connectivity graph, or a portion thereof, and having one or more parameters that are not trained; and (ii) one or more other neural networks having parameters that are trained. For example, the reservoir computing neural network can include an initial neural network layer with trainable parameters, followed by a sub-network layer having parameters that are not trained, followed by a third neural network layer with trainable parameters, followed by another sub-network having parameters that are not trained, followed by an output neural network layer. Other configurations of the reservoir computing neural network are also possible.

The reservoir computing system 400, shown in FIG. 4, includes a reservoir computing neural network 402 having (at least) two sub-networks: (i) a sub-graph neural network 418, where the sub-graph neural network 418 is a neural network architecture defined by any of the sub-graphs (202A, 202B, 202C), and (ii) a prediction neural network 404. The reservoir computing neural network 402 is configured to process a network input 406 to generate a network output 408. More specifically, the sub-graph neural network 418 is configured to process the network input 406 in accordance with a set of model parameters 410 of the sub-graph network 418 to generate an alternative representation 412 of the network input 406. The prediction neural network 404 is configured to process the alternative representation 412 of the network input 406 in accordance with a set of model parameters 414 of the prediction neural network 404 to generate the network output 408.

In some cases, the sub-graph neural network 418 can have a more complex neural network architecture than the prediction neural network 404. In one example, the prediction neural network 404 may include only one neural network layer (e.g., a fully-connected layer) that processes the alternative representation 412 of the network input 406 to generate the network output 408.

In some cases, the sub-graph neural network 418 may have a recurrent neural network architecture, e.g., where the connections in the architecture define one or more “loops.” More specifically, the architecture may include a sequence of components (e.g., nodes, layers, or groups of layers) such that the architecture includes a connection from each component in the sequence to the next component, and the first and last components of the sequence are identical. In one example, two nodes that are each directly connected to one another (e.g., where the first node provides its output the second node, and the second node provides its output to the first node) would form a recurrent loop.

A recurrent sub-graph neural network may process a network input over multiple (internal) time steps to generate a respective alternative representation 412 of the network input at each time step. In particular, at each time step, the sub-graph neural network may process: (i) the network input, and (ii) any outputs generated by the sub-graph neural network at the preceding time step, to generate the alternative representation for the time step. The reservoir computing neural network 402 may provide the alternative representation of the network input generated by the sub-graph neural network at the final time step as the input to the prediction neural network 404. The number of time steps over which the sub-graph neural network 418 processes a network input may be a predetermined hyper-parameter of the reservoir computing system 400.

In addition to processing the alternative representation 412 generated by the output layer of the sub-graph neural network 418, the prediction neural network 404 may additionally process one or more intermediate outputs of the sub-graph neural network 418. An intermediate output refers to an output generated by a hidden node of the sub-graph neural network, e.g., a node that is not included in the input layer or the output layer of the sub-graph neural network.

The reservoir computing system 400 includes a training engine 416 that is configured to train the reservoir computing neural network 402. Training the reservoir computing neural network 402 from end-to-end (e.g., training both the model parameters 410 of the sub-graph neural network 418 and the model parameters 414 of the prediction neural network 404) may be difficult due to the complexity of the architecture of the sub-graph neural network. In particular, the sub-graph neural network may have a very large number of trainable parameters and may have a highly recurrent architecture (e.g., an architecture that includes loops, as described above). Therefore, training the reservoir computing neural network 402 from end-to-end using machine learning training techniques may be computationally-intensive and the training may fail to converge, e.g., if the values of the model parameters of the reservoir computing neural network 402 oscillate rather than converging to fixed values. Even in cases where the training of the reservoir computing neural network 402 converges, the performance of the reservoir computing neural network 402 (e.g., measured by prediction accuracy) may fail to achieve an acceptable threshold.

For example, the large number of model parameters of the reservoir computing neural network 402 may overfit the limited amount of training data. Rather than training the entire reservoir computing neural network 402 from end-to-end, the training engine 416 only trains the model parameters 414 of the prediction neural network 704 while leaving the model parameters 410 of the sub-graph neural network 418 fixed during training. The model parameters, e.g., the weights, associated with the edges in the sub-graph neural network can be determined from the synaptic resolution image of the brain of the biological organism, as described in more detail below with reference to FIG. 6.

The distributed processing system 110 can use the architecture mapping system, described in more detail below with reference to FIG. 7, to map each sub-graph (202A, 202B, 202C) of the synaptic connectivity graph 108 onto a corresponding sub-graph neural network architecture, and instantiate each individual sub-graph neural network architecture as an individual reservoir computing neural network 402, as described above. The distributed processing system 110 can assign each sub-graph to an individual processing unit (204A, 204B, 204C). For each sub-graph that is assigned to a processing unit, the processing unit instantiates the corresponding reservoir computing neural network, trains it by using a set of training data, and evaluates its performance on a particular machine learning task by using a set of validation data. Next, the processing unit calculates a performance measure defining a performance of the reservoir computing neural network at the machine learning task.

The distributed processing system 110 can aggregate the performance measures generated by the processing units for each of the sub-graphs and identify the best neural network architecture for performing the machine learning task (e.g., the neural network architecture with the highest performance measure).

FIG. 5 is a flow diagram of an example process 500 for processing data using a reservoir computing neural network that includes: (i) a sub-graph neural network, referring to a neural network architecture that is specified by any of the sub-graphs generated by the distributed processing 110, and (ii) a prediction sub-network. For convenience, the process 500 will be described as being performed by a system of one or more computers located in one or more locations. For example, a reservoir computing system, e.g., the reservoir computing system 400 of FIG. 5, appropriately programmed in accordance with this specification, can perform the process 500.

The system receives a network input to the processed by the reservoir computing neural network (502).

The system processes the network input using the sub-graph neural network to generate an alternative representation of the network input (504). The system determines the values of the sub-graph neural network parameters before the reservoir computing neural network is trained and holds them fixed them during training of the reservoir computing neural network. The sub-graph neural network has a neural network architecture that is specified by a sub-graph generated by the distributed processing system 110. The sub-graph has a set of nodes and a set of edges, where each edge connects a pair of nodes.

The system processes the alternative representation of the network input using the prediction sub-network to generate the network output (i.e., of the reservoir computing neural network) (506). The system adjusts the values of the prediction sub-network parameters during training of the reservoir computing neural network.

FIG. 6 shows an example data flow 600 for generating a synaptic connectivity graph 108 based on the brain 104 of a biological organism 106. An imaging system 608 may be used to generate a synaptic resolution image 610 of the brain 606. An image of the brain 606 may be referred to as having synaptic resolution if it has a spatial resolution that is sufficiently high to enable the identification of at least some synapses in the brain 606. Put another way, an image of the brain 606 may be referred to as having synaptic resolution if it depicts the brain 606 at a magnification level that is sufficiently high to enable the identification of at least some synapses in the brain 606. The image 610 may be a volumetric image, i.e., that characterizes a three-dimensional representation of the brain 606. The image 610 may be represented in any appropriate format, e.g., as a three-dimensional array of numerical values.

The imaging system 608 may be any appropriate system capable of generating synaptic resolution images, e.g., an electron microscopy system. The imaging system 608 may process “thin sections” from the brain 606 (i.e., thin slices of the brain attached to slides) to generate output images that each have a field of view corresponding to a proper subset of a thin section. The imaging system 608 may generate a complete image of each thin section by stitching together the images corresponding to different fields of view of the thin section using any appropriate image stitching technique. The imaging system 608 may generate the volumetric image 610 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system 612 is configured to process the synaptic resolution image 610 to generate the synaptic connectivity graph 602. The synaptic connectivity graph 602 specifies a set of nodes and a set of edges, such that each edge connects two nodes. To generate the graph 602, the graphing system 612 identifies each neuron in the image 610 as a respective node in the graph, and identifies each synaptic connection between a pair of neurons in the image 610 as an edge between the corresponding pair of nodes in the graph.

The graphing system 612 may identify the neurons and the synapses depicted in the image 610 using any of a variety of techniques. For example, the graphing system 612 may process the image 610 to identify the positions of the neurons depicted in the image 610, and determine whether a synapse connects two neurons based on the proximity of the neurons (as will be described in more detail below). In this example, the graphing system 612 may process an input including: (i) the image, (ii) features derived from the image, or (iii) both, using a machine learning model that is trained using supervised learning techniques to identify neurons in images. The machine learning model may be, e.g., a convolutional neural network model or a random forest model. The output of the machine learning model may include a neuron probability map that specifies a respective probability that each voxel in the image is included in a neuron. The graphing system 612 may identify contiguous clusters of voxels in the neuron probability map as being neurons.

Optionally, prior to identifying the neurons from the neuron probability map, the graphing system 612 may apply one or more filtering operations to the neuron probability map, e.g., with a Gaussian filtering kernel. Filtering the neuron probability map may reduce the amount of “noise” in the neuron probability map, e.g., where only a single voxel in a region is associated with a high likelihood of being a neuron.

The machine learning model used by the graphing system 612 to generate the neuron probability map may be trained using supervised learning training techniques on a set of training data. The training data may include a set of training examples, where each training example specifies: (i) a training input that can be processed by the machine learning model, and (ii) a target output that should be generated by the machine learning model by processing the training input. For example, the training input may be a synaptic resolution image of a brain, and the target output may be a “label map” that specifies a label for each voxel of the image indicating whether the voxel is included in a neuron. The target outputs of the training examples may be generated by manual annotation, e.g., where a person manually specifies which voxels of a training input are included in neurons.

Example techniques for identifying the positions of neurons depicted in the image 610 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 612 may identify the synapses connecting the neurons in the image 610 based on the proximity of the neurons. For example, the graphing system 612 may determine that a first neuron is connected by a synapse to a second neuron based on the area of overlap between: (i) a tolerance region in the image around the first neuron, and (ii) a tolerance region in the image around the second neuron. That is, the graphing system 612 may determine whether the first neuron and the second neuron are connected based on the number of spatial locations (e.g., voxels) that are included in both: (i) the tolerance region around the first neuron, and (ii) the tolerance region around the second neuron.

For example, the graphing system 612 may determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron may be specified as the set of spatial locations in the image that are either: (i) in the interior of the neuron, or (ii) within a predefined distance of the interior of the neuron.

The graphing system 612 may further identify a weight value associated with each edge in the graph 602. For example, the graphing system 612 may identify a weight for an edge connecting two nodes in the graph 602 based on the area of overlap between the tolerance regions around the respective neurons corresponding to the nodes in the image 610. The area of overlap may be measured, e.g., as the number of voxels in the image 610 that are contained in the overlap of the respective tolerance regions around the neurons. The weight for an edge connecting two nodes in the graph 602 may be understood as characterizing the (approximate) strength of the connection between the corresponding neurons in the brain (e.g., the amount of information flow through the synapse connecting the two neurons).

In addition to identifying synapses in the image 610, the graphing system 612 may further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 612 determines the directions of the synapses in the image 610, the graphing system 612 may associate each edge in the graph 602 with direction of the corresponding synapse. That is, the graph 602 may be a directed graph. In other implementations, the graph 602 may be an undirected graph, i.e., where the edges in the graph are not associated with a direction.

The graph 602 may be represented in any of a variety of ways. For example, the graph 602 may be represented as a two-dimensional array of numerical values with a number of rows and columns equal to the number of nodes in the graph. The component of the array at position (i,j) may have value 1 if the graph includes an edge pointing from node i to node j, and value 0 otherwise. In implementations where the graphing system 612 determines a weight value for each edge in the graph 602, the weight values may be similarly represented as a two-dimensional array of numerical values. More specifically, if the graph includes an edge connecting node i to node j, the component of the array at position (i,j) may have a value given by the corresponding edge weight, and otherwise the component of the array at position (i,j) may have value 0.

FIG. 7 is a flow diagram of an example process 700 for generating a neural network architecture corresponding to a graph, which can be the synaptic connectivity graph 108, or a sub-graph (202A, 202B, 202C) generated by the distributed processing system 110. For convenience, the process 700 will be described as being performed by an architecture mapping system, which is a system of one or more computers located in one or more locations.

The architecture mapping system can instantiate a respective neuron in the neural network architecture corresponding to each node in a graph (702). For example, the architecture mapping system can map each edge connecting a pair of nodes in the sub-graph to a connection between a corresponding pair of artificial neurons in the neural network architecture. Next, the architecture mapping system can instantiate a respective connection in the neural network architecture corresponding to each edge in the sub-graph (704). For example, the architecture mapping system can map each edge connecting a pair of nodes in the candidate synthetic graph to a connection between a corresponding pair of artificial neurons in the neural network architecture. The details of the process 700 are described in more detail below.

In one example, a neural network architecture corresponding to a graph may include: (i) a respective artificial neuron corresponding to each node in the graph, and (ii) a respective connection corresponding to each edge in the graph. In this example, the graph may be a directed graph, and an edge that points from a first node to a second node in the graph may specify a connection pointing from a corresponding first artificial neuron to a corresponding second artificial neuron in the architecture. The connection pointing from the first artificial neuron to the second artificial neuron may indicate that the output of the first artificial neuron should be provided as an input to the second artificial neuron. Each connection in the architecture may be associated with a weight value, e.g., that is specified by the weight value associated with the corresponding edge in the graph.

An artificial neuron may refer to a component of the architecture that is configured to receive one or more inputs (e.g., from one or more other artificial neurons), and to process the inputs to generate an output. The inputs to an artificial neuron and the output generated by the artificial neuron may be represented as scalar numerical values. In one example, a given artificial neuron may generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁^{L} are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the graph may be an undirected graph, and the architecture mapping system may map an edge that connects a first node to a second node in the graph to two connections between a corresponding first artificial neuron and a corresponding second artificial neuron in the architecture. In particular, the architecture mapping system may map the edge to: (i) a first connection pointing from the first artificial neuron to the second artificial neuron, and (ii) a second connection pointing from the second artificial neuron to the first artificial neuron.

In another example, the graph may be an undirected graph, and the architecture mapping system may map an edge that connects a first node to a second node in the graph to one connection between a corresponding first artificial neuron and a corresponding second artificial neuron in the architecture. The architecture mapping system may determine the direction of the connection between the first artificial neuron and the second artificial neuron, e.g., by randomly sampling the direction in accordance with a probability distribution over the set of two possible directions.

In some cases, the edges in the graph may not be associated with weight values, and the weight values corresponding to the connections in the architecture may be determined randomly. For example, the weight value corresponding to each connection in the architecture may be randomly sampled from a predetermined probability distribution, e.g., a standard Normal (N(0,1)) probability distribution.

In another example, the neural network architecture corresponding to a graph may include: (i) a respective artificial neural network layer corresponding to each node in the graph, and (ii) a respective connection corresponding to each edge in the graph. In this example, a connection pointing from a first layer to a second layer may indicate that the output of the first layer should be provided as an input to the second layer. An artificial neural network layer may refer to a collection of artificial neurons, and the inputs to a layer and the output generated by the layer may be represented as ordered collections of numerical values (e.g., tensors of numerical values). In one example, the architecture may include a respective convolutional neural network layer corresponding to each node in the graph, and each given convolutional layer may generate an output d as:

$$d = σ ( {h}_{θ} ( {\sum }_{i = 1}^{n} {w}_{i} \cdot {c}_{i} ) ) \qquad ( 2 )$$

where each cᵢ (i=1, n) is a tensor (e.g., a two- or three-dimensional array) of numerical values provided as an input to the layer, each wᵢ (i=1, n) is a weight value associated with the connection between the given layer and each of the other layers that provide an input to the given layer (where the weight value for each edge may be specified by the weight value associated with the corresponding edge in the sub-graph), h_{θ}(⋅) represents the operation of applying one or more convolutional kernels to an input to generate a corresponding output, and σ(⋅) is a non-linear activation function that is applied element-wise to each component of its input. In this example, each convolutional kernel may be represented as an array of numerical values, e.g., where each component of the array is randomly sampled from a predetermined probability distribution, e.g., a standard Normal probability distribution.

In another example, the architecture mapping system may determine that the neural network architecture corresponding to a graph includes: (i) a respective group of artificial neural network layers corresponding to each node in the graph, and (ii) a respective connection corresponding to each edge in the graph. The layers in a group of artificial neural network layers corresponding to a node in the graph may be connected, e.g., as a linear sequence of layers, or in any other appropriate manner.

The neural network architecture may include one or more artificial neurons that are identified as “input” artificial neurons and one or more artificial neurons that are identified as “output” artificial neurons. An input artificial neuron may refer to an artificial neuron that is configured to receive an input from a source that is external to the neural network. An output artificial neural neuron may refer to an artificial neuron that generates an output which is considered part of the overall output generated by the neural network. The architecture mapping system may add artificial neurons to the architecture in addition to those specified by nodes in the graph, and designate the added neurons as input artificial neurons and output artificial neurons.

For example, for a neural network that is configured to process an input including a 100×100 image to generate an output indicating whether the image is included in each of 1000 categories, the architecture mapping system may add 10,000 (=100×100) input artificial neurons and 1000 output artificial neurons to the architecture. Input and output artificial neurons that are added to the architecture may be connected to the other neurons in the architecture in any of a variety of ways. For example, the input and output artificial neurons may be densely connected to every other neuron in the architecture.

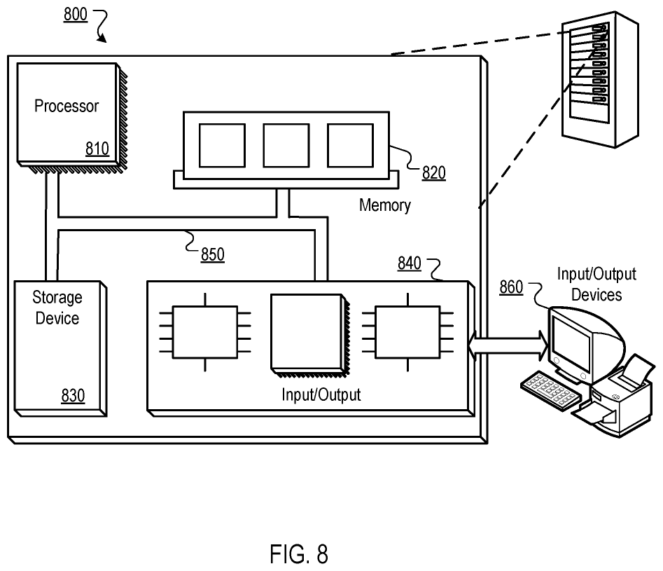

FIG. 8 is a block diagram of an example computer system 800 that can be used to perform operations described previously. The system 800 includes a processor 810, a memory 820, a storage device 830, and an input/output device 840. Each of the components 810, 820, 830, and 840 can be interconnected, for example, using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can include, for example, a hard disk device, an optical disk device, a storage device that is shared over a network by multiple computing devices (for example, a cloud storage device), or some other large capacity storage device.

The input/output device 840 provides input/output operations for the system 800. In one implementation, the input/output device 840 can include one or more network interface devices, for example, an Ethernet card, a serial communication device, for example, and RS-232 port, and/or a wireless interface device, for example, and 802.11 card. In another implementation, the input/output device 840 can include driver devices configured to receive input data and send output data to other input/output devices, for example, keyboard, printer and display devices 860. Other implementations, however, can also be used, such as mobile computing devices, mobile communication devices, and set-top box television client devices.

Although an example processing system has been described in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by a plurality of data processing units for distributed processing of data defining a synaptic connectivity graph that represents synaptic connectivity between neurons in a brain of a biological organism, wherein the synaptic connectivity graph comprises a plurality of nodes and edges, the method comprising:
obtaining graph data defining the synaptic connectivity graph that represents synaptic connectivity between neurons in the brain of the biological organism;
dividing the graph data defining the synaptic connectivity graph into a plurality of sub-graph datasets that each define a respective sub-graph of the synaptic connectivity graph;
distributing the plurality of sub-graph datasets over the plurality of data processing units, comprising assigning each sub-graph dataset to a respective data processing unit; and
processing the plurality of sub-graph datasets using the plurality of data processing units, comprising, for each of the plurality of data processing units, processing one or more sub-graph datasets that are assigned to the data processing unit.

2. The method of claim 1, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism.

3. The method of claim 1, wherein, for each of the plurality of data processing units, processing one or more sub-graph datasets that are assigned to the data processing unit comprises, for each sub-graph dataset that is assigned to the data processing unit:
instantiating a reservoir computing neural network comprising: (i) a sub-graph neural network having a neural network architecture that is specified by the sub-graph dataset; and (ii) a prediction neural network.

4. The method of claim 3, wherein instantiating the reservoir computing network comprises instantiating the sub-graph neural network having the neural network architecture that is specified by the sub-graph dataset, comprising:
mapping each node in the sub-graph dataset to a corresponding artificial neuron in the neural network architecture; and
mapping each edge connecting a pair of nodes in the sub-graph dataset to a connection between a corresponding pair of artificial neurons in the neural network architecture.

5. The method of claim 3, further comprising training the reservoir computing network and evaluating a performance of the reservoir computing network on a machine learning task, wherein the performance of the reservoir computing network is characterized by a performance measure.

6. The method of claim 5, wherein the machine learning task is an image processing task, an audio data processing task, an odor processing task, or a natural language processing task.

7. The method of claim 1, wherein, for each of the plurality of data processing units, processing one or more sub-graph datasets that are assigned to the data processing unit comprises, for each sub-graph dataset that is assigned to the data processing unit: rendering a visualization of the sub-graph dataset by the data processing unit.

8. The method of claim 7, wherein the visualization comprises a plurality of markers, wherein each marker indicates a position of each node, and wherein the position of each node is defined by a position of a corresponding neuron in the brain of the biological organism.

9. The method of claim 7, further comprising aggregating visualizations of the sub-graph datasets generated by each processing unit to generate a visualization of a whole of the synaptic connectivity graph.

10. The method of claim 1, wherein, for each of the plurality of data processing units, processing one or more sub-graph datasets that are assigned to the data processing unit comprising, for each sub-graph dataset that is assigned to the data processing unit: calculating graph statistics characterizing the sub-graph dataset, the graph statistics comprising one or more of: a sum of clustering coefficients for each node in the sub-graph dataset averaged over a total number of nodes in the sub-graph dataset, a total number of loops in the sub-graph dataset averaged over the total number of nodes in the sub-graph dataset, a total number of edges connected to each node in the sub-graph dataset averaged over the total number of nodes in the sub-graph dataset, and a small-world parameter for the sub-graph dataset.

11. The method of claim 1, wherein each division of the graph data defining the synaptic connectivity graph into the plurality of sub-graph datasets is associated with a respective score, and wherein dividing the graph data comprises: determining the division of the graph data into the plurality of sub-graph datasets, by a graph clustering algorithm, to optimize the score associated with the division of the graph data into the plurality of sub-graph datasets.

12. The method of claim 11, wherein the score is based on one or more of: small-world parameters of each sub-graph, average clustering coefficient of each sub-graph, average number of edges connected to each node in each sub-graph, average number of loops in each sub-graph.

13. The method of claim 1, wherein the biological organism is an animal.

14. The method of claim 1, wherein the biological organism is a fly.

15. The method of claim 1, wherein the plurality of data processing units process the sub-graph datasets in parallel.

16. One or more non-transitory computer storage media storing instructions that when executed by a plurality of data processing units cause the plurality of data processing units to perform operations for distributed processing of data defining a synaptic connectivity graph that represents synaptic connectivity between neurons in a brain of a biological organism, wherein the synaptic connectivity graph comprises a plurality of nodes and edges, the operations comprising:
obtaining graph data defining the synaptic connectivity graph that represents synaptic connectivity between neurons in the brain of the biological organism;
dividing the graph data defining the synaptic connectivity graph into a plurality of sub-graph datasets that each define a respective sub-graph of the synaptic connectivity graph;
distributing the plurality of sub-graph datasets over the plurality of data processing units, comprising assigning each sub-graph dataset to a respective data processing unit; and
processing the plurality of sub-graph datasets using the plurality of data processing units, comprising, for each of the plurality of data processing units, processing one or more sub-graph datasets that are assigned to the data processing unit.

17. A system comprising:
a plurality of data processing units; and
one or more storage devices commutatively coupled to the plurality of data processing units, wherein the one or more storage devices store instructions that, when executed by the plurality of data processing units, cause the plurality of data processing units to perform operations for distributed processing of data defining a synaptic connectivity graph that represents synaptic connectivity between neurons in a brain of a biological organism, wherein the synaptic connectivity graph comprises a plurality of nodes and edges, the operations comprising:
obtaining graph data defining the synaptic connectivity graph that represents synaptic connectivity between neurons in the brain of the biological organism;
dividing the graph data defining the synaptic connectivity graph into a plurality of sub-graph datasets that each define a respective sub-graph of the synaptic connectivity graph;
distributing the plurality of sub-graph datasets over the plurality of data processing units, comprising assigning each sub-graph dataset to a respective data processing unit; and
processing the plurality of sub-graph datasets using the plurality of data processing units, comprising, for each of the plurality of data processing units, processing one or more sub-graph datasets that are assigned to the data processing unit.

18. The system of claim 17, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism.

19. The system of claim 17, wherein, for each of the plurality of data processing units, processing one or more sub-graph datasets that are assigned to the data processing unit comprises, for each sub-graph dataset that is assigned to the data processing unit: instantiating a reservoir computing neural network comprising: (i) a sub-graph neural network having a neural network architecture that is specified by the sub-graph dataset; and (ii) a prediction neural network.

20. The system of claim 17, wherein each division of the graph data defining the synaptic connectivity graph into the plurality of sub-graph datasets is associated with a respective score, and wherein dividing the graph data comprises: determining the division of the graph data into the plurality of sub-graph datasets, by a graph clustering algorithm, to optimize the score associated with the division of the graph data into the plurality of sub-graph datasets.
